(19) United States
(12) Patent Application Publication
(10) Pub. No.: US 2025/0060249 A1
(43) Pub. Date: Feb. 20, 2025

(54) SPECTROMETER, SPECTROSCOPIC MEASUREMENT RESULT DISPLAY METHOD, AND MEMORY MEDIUM

(71) Applicant: SEIKO EPSON CORPORATION, Tokyo (JP)

(72) Inventor: Ryohei KURI, Minowa-Machi (JP)

(21) Appl. No.: 18/806,747

(22) Filed: Aug. 16, 2024

(30) Foreign Application Priority Data
Aug. 18, 2023 (JP) 2023-133597

(51) Int. Cl. G01J 3/02; G01J 3/28; G01J 3/46

(52) U.S. Cl. CPC G01J 3/0264; G01J 3/2823; G01J 3/463

(57) ABSTRACT

A spectrometer includes a spectroscopic measurement section that performs spectroscopic measurement of a target object and that acquires a spectral image, a display section, and a control section that generates Lab visualization information from the spectral image and that causes the display section to display the Lab visualization information. It is desirable that the Lab visualization information is an L-image obtained by converting L-values into luminance for each pixel, an a-image obtained by converting a-values into luminance for each pixel, or a b-image obtained by converting b-values into luminance for each pixel.

### CROSS-REFERENCE TO RELATED APPLICATIONS

The present application is based on, and claims priority from JP Application Serial Number 2023-133597, filed Aug. 18, 2023, the disclosure of which is hereby incorporated by reference herein in its entirety.

### BACKGROUND OF THE INVENTION

### 1. Technical Field

The present disclosure relates to a spectrometer, a spectroscopic measurement result display method, and a spectroscopic measurement result display program.

### 2. Related Art

Because a color unevenness inspection apparatus for acquiring a spectral image of a target object and inspecting color unevenness can quantitatively evaluate the color unevenness of the target object, its application to various fields has been studied.

For example, JP-A-2022-157667 discloses a skin color unevenness display apparatus provided with a calculation means for calculating a color difference from an adjacent pixel for each pixel in a skin image of a subject, and a display means for displaying a frequency of appearance of a calculated value of the color difference in a graph or chart. The color unevenness display device first acquires an RGB skin image acquired by the digital camera, and converts the RGB image into an L*a*b* image.

Next, the color difference of adjacent pixels is calculated from the L*a*b* image. Also, the calculated values of the color difference are divided into groups based on the values and then the composition ratio of each group is graphed and displayed. By this, it is possible to intuitively recognize the degree of color unevenness.

RGB images can represent only a portion of the color gamut that is visible to the human eye. For this reason, in the L*a*b* image obtained by the color unevenness display apparatus described in JP-A-2022-157667, there is a possibility that color information originally possessed by the target object is missing. As a result, there is a possibility that the color unevenness of the target object cannot be accurately detected by the color unevenness inspection apparatus. On the other hand, for example, when detected color unevenness is minute, displaying the detection result of the color unevenness in an easy-to-understand manner and intuitively conveying it to the user is also an issue.

Accordingly, it is an issue to provide a spectrometer capable of accurately detecting color information of a target object and displaying the detected color information so it can be intuitively understood.

### SUMMARY OF THE INVENTION

A spectrometer according to an application example of the present disclosure includes
a spectroscopic measurement section that performs spectroscopic measurement of a target object and acquires a spectral image;
a display section; and
a control section that generates Lab visualization information from the spectral image and displays the Lab visualization information on the display section.

A spectroscopic measurement result display method according to an application example of the present disclosure is
a method of displaying a spectroscopic measurement result of a target object on a display section and includes
acquiring a spectral image of the target object;
generating Lab visualization information from the spectral image; and
displaying the Lab visualization information on the display section.

A non-transitory memory medium storing a spectroscopic measurement result display program according to an application example of the present disclosure is
a non-transitory memory medium storing a spectroscopic measurement result display program for causing a computer to perform a process of displaying a spectroscopic measurement result of a target object on a display section, and causing the computer to perform
a spectral image acquisition process of acquiring a spectral image of the target object;
an Lab information generation process of generating Lab visualization information from the spectral image; and
an Lab information display process for displaying the Lab visualization information on the display section.

### BRIEF DESCRIPTION OF DRAWINGS

FIG. 1 is a schematic diagram showing a spectrometer according to a first embodiment.

FIG. 2 is a functional block diagram of the spectrometer shown in FIG. 1.

FIG. 3 is a diagram showing an example of a hardware configuration for realizing the functions of the functional sections provided in the spectrometer of FIG. 2.

FIG. 4 is a flow chart showing the configuration of a spectroscopic measurement result display method according to the first embodiment.

FIG. 5 shows an example of a display screen including a preview image displayed in a preview image acquisition step and an Lab-image displayed in the Lab-image display step.

FIG. 6 shows an example of an input screen for supporting the input of an environment setting value in an environment setting value reception step.

FIG. 7 shows an example of an input screen for supporting input of normalization parameters in a normalization process step.

FIG. 8 is a flow chart showing a configuration of a spectroscopic measurement result display method according to a modification of the first embodiment.

FIG. 9 shows an example of a display screen including a preview image and a settings field displayed in a preview image acquisition step in the modification of the first embodiment.

FIG. 10 shows an example of the display screen including an L-image displayed in an Lab-image display step in the modification of the first embodiment.

FIG. 11 shows an example of the display screen including the L-image after image processing in an image processing step.

FIG. 12 shows an example of the display screen including the L-image after image processing in the image processing step.

FIG. 13 is a flow chart showing the configuration of a spectroscopic measurement result display method according to a second embodiment.

FIG. 14 is an example of a display screen including a preview image displayed in a preview image acquisition step and an Lab histogram displayed in an Lab histogram display step in the second embodiment.

FIG. 15 is a conceptual diagram showing an example of the difference between an L-histogram, an a-histogram, and a b-histogram.

FIG. 16 is a flow chart showing configuration of a spectroscopic measurement result display method according to a modification of the second embodiment.

FIG. 17 shows an example of a display screen including a preview image and a settings field displayed in the preview image acquisition step in the modification of the second embodiment.

FIG. 18 shows an example of the display screen including an L-histogram displayed in an Lab histogram display step in the modification of the second embodiment.

FIG. 19 is a scatter diagram obtained by plotting the reference data and the measurement data, and a graph showing a regression line obtained by linearly approximating the plot marks.

FIG. 20 is a graph HS of reference data, a graph HM of measurement data, and a graph HD of the difference obtained by subtracting the graph HM from the graph HS.

FIG. 21 is a conceptual diagram showing the distances between a range A occupied by a plurality of acceptance data, a range B occupied by a plurality of rejection data, and measurement data M.

### DETAILED DESCRIPTION OF THE INVENTION

Hereinafter, a spectrometer, a spectroscopic measurement result display method, and a spectroscopic measurement result display program of the present disclosure will be described in detail based on embodiments shown in the accompanying drawings.

### 1. First Embodiment

First, a first embodiment will be described.

### 1.1. Spectrometer

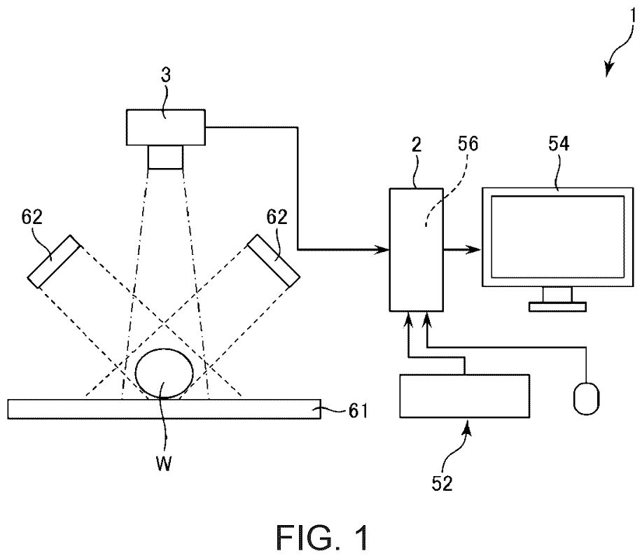

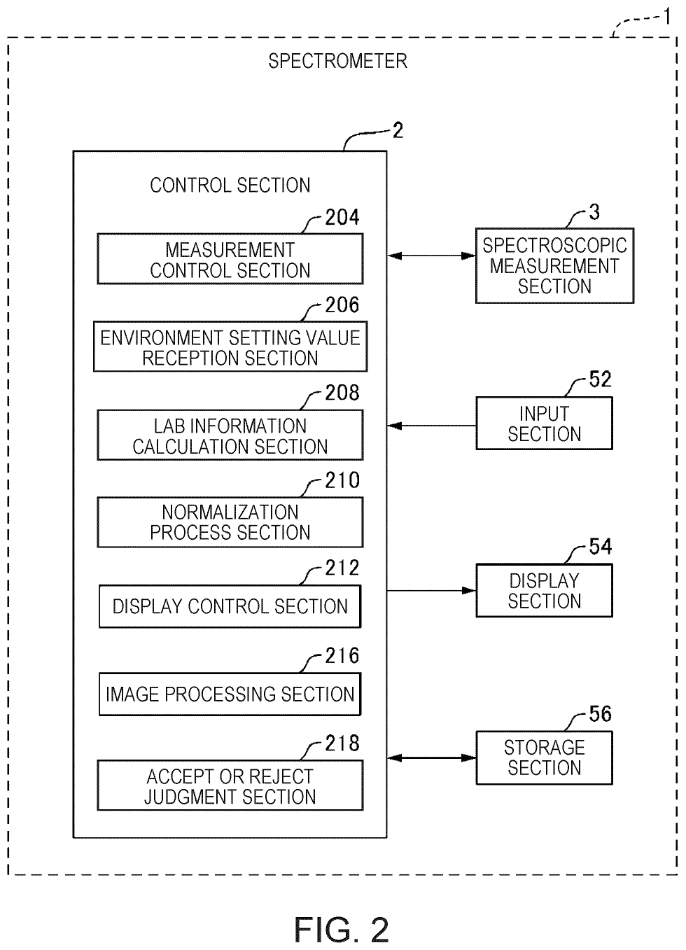

FIG. 1 is a schematic diagram showing a spectrometer 1 according to the first embodiment. FIG. 2 is a functional block diagram of the spectrometer 1 shown in FIG. 1.

### 1.1.1. Overview of Equipment

The spectrometer 1 shown in FIG. 1 includes a control section 2, a spectroscopic measurement section 3, an input section 52, a display section 54, a storage section 56, a stage 61, and a light source 62. The spectrometer 1 performs spectroscopic measurement of a target object W and acquires a spectral image. Spectroscopic measurement refers to obtaining a spectrum (spectroscopic data) by separating, for each pixel, reflected light reflected from a target object W. Spectral image refers to cube data in which images at each spectral wavelength are collected.

The control section 2 controls the operation of the spectroscopic measurement section 3. The control section 2 has a function of receiving input from the input section 52, a function of displaying information on the display section 54, a function of writing and reading information to and from the storage section 56, and the like.

The spectroscopic measurement section 3 has a spectroscopic section and an image pickup element (neither of which are shown). The light emitted from the light source 62 is reflected by the target object W and enters the spectroscopic measurement section 3 as reflected light. The spectroscopic section is an optical element having a function of selecting light in a specific wavelength region from among the reflected light. The selected light is incident on the image pickup element. The image pickup element is an image sensor having a function of detecting a two dimensional distribution of the intensity of incident light. A two dimensional image can be picked up at various wavelengths by the image pickup element by switching the specific wavelength selected by the spectroscopic section. By this, spectral images are obtained. Note that the spectroscopic measurement section 3 may have a function of acquiring, for example, a monochrome image, an RGB image, or the like. Since these images can be acquired in a shorter time than a spectral image, they can be used as preview images.

The input section 52 receives an input operation by a user of the spectrometer 1. The input information received by the input section 52 is transmitted to the control section 2.

The display section 54 displays the display information output from the control section 2. By this, the user of spectrometer 1 can visually check the display information.

The storage section 56 stores programs, data, setting values, and the like necessary for the operation of the control section 2. The storage section 56 corresponds to reading a program or the like from the control section 2 and writing data or the like into the control section 2.

The stage 61 is a stand on which the target object W is placed. The light source 62 irradiates the target object W with light. The irradiation method of the light source 62 may be appropriately selected according to the type of target object W or the like.

### 1.1.2. Control Section

The control section 2 depicted in FIG. 2 includes, as functional sections, a measurement control section 204, an environment setting value reception section 206, an Lab information calculation section 208, a normalization process section 210, a display control section 212, an image processing section 216, and an accept or reject judgment section 218.

The measurement control section 204 controls the operation of the spectroscopic measurement section 3 and causes the spectroscopic measurement section 3 to acquire a spectral image and a preview image. The measurement control section 204 stores the acquired spectral image and preview image in the storage section 56. The acquisition of the spectral image and the preview image is executed, for example, by an input operation through the input section 52.

The environment setting value reception section 206 receives the environment setting value used when generating an L-image, an a-image, or a b-image from a spectral image. An L-image is an image obtained by converting L-values into luminance for each pixel. An a-image and a b-image are images obtained by converting a-values and b-values into luminance for each pixel. Note that in the present specification, L-value refers to L* values representing lightness in the L*a*b* color space standardized by the International Commission on Illumination (CIE) in 1976. As used herein, a-value refers to a* values representing chromaticity in the L*a*b* color space. Further, in the present specification, b value refers to b* values representing chromaticity in the L*a*b* color space. Examples of the environment setting value include a color matching function, an illumination light source, and the like, and one or both of these are used. Note that in the following description, at least one of the L-value, the a-value, and the b-value is indicated by referring to it as an Lab-value. At least one of an L-image, an a-image, or an b-image is indicated by referring to it as an Lab-image. An Lab-image in the present specification is one of Lab visualization information obtained by extracting and visualizing at least one of an L-value, an a-value, and a b-value for each pixel.

The color matching function is a function representing the spectral sensitivity to the human eye. Examples of the color matching function include a color matching function of a CIE1931 standard colorimetric observer (a two degree field of view color matching function) and a color matching function of a CIE1964 colorimetric supplementary standard observer (a ten degree field of view color matching function).

The illumination light source is a standard light source defined to reproduce the illumination environment. Examples of the illumination light source include a CIE standard light source D50, a CIE standard light source D65, an incandescent lamp A, a standard illuminant C, a cool white fluorescent light CWF, and a fluorescent light TL84.

The Lab information calculation section 208 generates Lab-images based on the spectral images and the environment setting value. Specifically, the L-value, the a-value, and the b-value are extracted for each pixel from the spectroscopic data for each pixel included in the spectral image based on the environment setting value. Then, the L-value is converted into luminance to generate an L-image. For example, when the L-image is a 256-tone bitmap image, the minimum extracted L-value may be set to correspond to a luminance of 0, and the maximum L-value may be set to correspond to a luminance of 255. Similarly, the a-value is converted into luminance to generate an a-image, and the b-value is converted into luminance to generate a b-image. By generating the Lab-image based on the environment setting value, the Lab-image can be obtained with more accurate extraction of color information of the target object W. Note that the correspondence between the Lab-value and the luminance is not limited to the above-mentioned method.

The normalization process section 210 normalizes the luminance widths of the L-image, the a-image, and the b-image. This normalization process is performed based on each range of the extracted L-values, a-values, and b-values. The ranges may be arbitrarily designated ranges in addition to ranges from the minimum value to the maximum value of the Lab-values described above.

For example, the normalization process section 210 may perform processing for determining each of the above-described ranges based on each range of the Lab-values in the two dimensional regions input through the input section 52. The normalization process section 210 may perform processing for determining each range on the basis of the specified values input through the input section 52. In this specification, these two dimensional regions and specified values are also referred to as “normalization parameters”.

The display control section 212 has a function of causing the display section 54 to display the Lab-image or the preview image mentioned above. The display control section 212 may have a function of causing the display section 54 to display, for example, a graphical user interface (GUI) screen for receiving input or selection of an environment setting value, a GUI screen for receiving input of a normalization parameter, the result of image processing by the image processing section 216, a result of an accept or reject judgment process by the accept or reject judgment section 218, and the like.

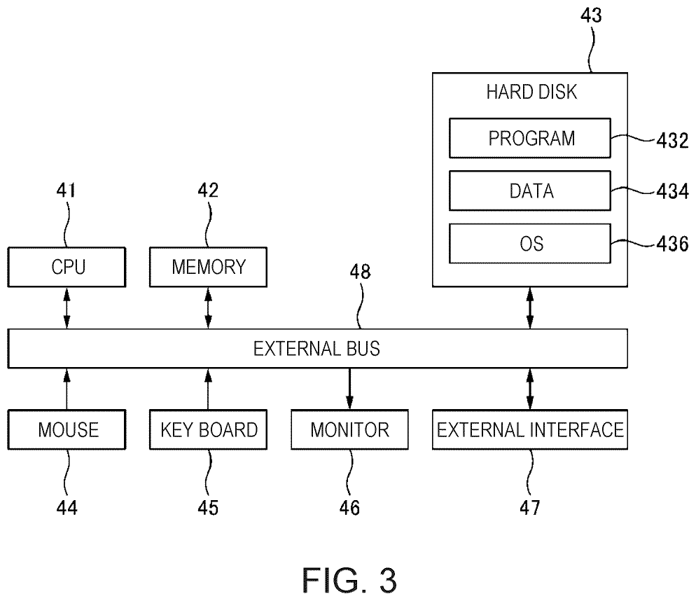

FIG. 3 is a diagram showing an example of hardware configuration for realizing the functions of the functional section provided in spectrometer 1 of FIG. 2.

The functions of the functional sections of the spectrometer 1 are realized, for example, by hardware including a CPU 41, a memory 42, a hard disk 43, a mouse 44, a key board 45, a monitor 46, an external interface 47, and an external bus 48 shown in FIG. 3. Among these, the CPU 41, the memory 42, the hard disk 43, the external interface 47, and the external bus 48 are, for example, components of a computer.

The CPU 41 is a central processing unit. Examples of the memory 42 include an arbitrary non-volatile storage element (ROM), an arbitrary volatile storage element (RAM), and a detachable external storage element. Examples of the external interface 47 include a digital input/output port such as a universal serial bus (USB), an Ethernet (registered trademark) port, and a video output port. The hard disk 43 stores a program 432, data 434, and an OS 436. The program 432 includes a spectroscopic measurement result display program (to be described later). The data 434 is, for example, a spectral image, an Lab-image, an environment setting value, a normalization parameter, or the like. OS 436 is an operating system. The hard disk 43 may be a storage medium such as a flash memory or a Solid State Drive (SSD), for example. All or a part of the hardware may be constituted by a field-programmable gate array (FPGA), an application specific integrated circuit (ASIC), or the like. Further, instead of or in addition to at least one of the mouse 44 and the key board 45, for example, a touch panel, a touch pad, a microphone, or the like may be provided.

The program 432 is loaded into the memory 42 and executed by the CPU 41. When the CPU 41 executes the program 432, the functions of the functional sections described above are realized.

Note that the spectroscopic measurement result display program may be stored in a nonvolatile storage medium (a storage medium readable by a computer). The program 432 and the data 434 may be provided externally through a network.

### 1.2. Spectroscopic Measurement Result Display Method

Next, a spectroscopic measurement result display method according to the first embodiment will be described.

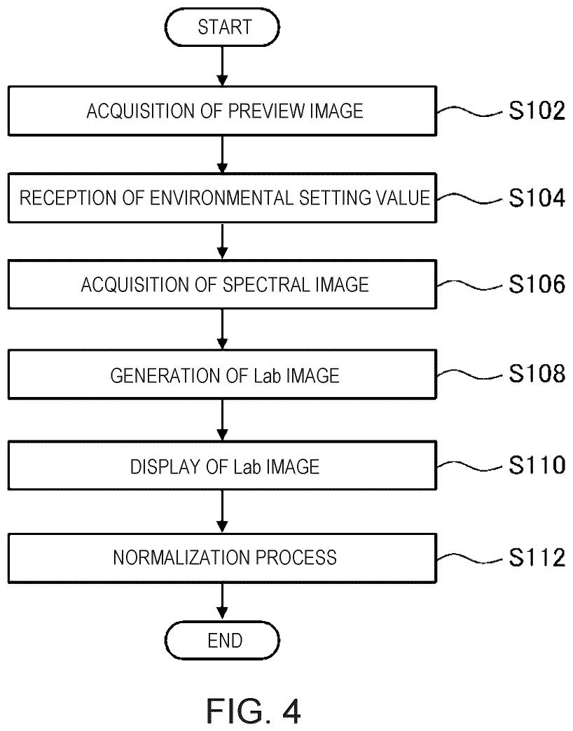

FIG. 4 is a flow chart showing the configuration of a spectroscopic measurement result display method according to the first embodiment. The spectroscopic measurement result display method shown in FIG. 4 is performed, for example, by the CPU 41 executing the OS 436 and the spectroscopic measurement result display program included in the program 432. Note that the CPU 41 may execute only the spectroscopic measurement result display program.

The spectroscopic measurement result display method shown in FIG. 4 includes a preview image acquisition step S102, an environment setting value reception step S104, a spectral image acquisition step S106, an Lab-image generation step S108, an Lab-image display step S110, and a normalization process step S112.

### 1.2.1. Preview Image Acquisition Step

In the preview image acquisition step S102, the computer is caused to perform a preview image acquisition process and a preview image displaying process.

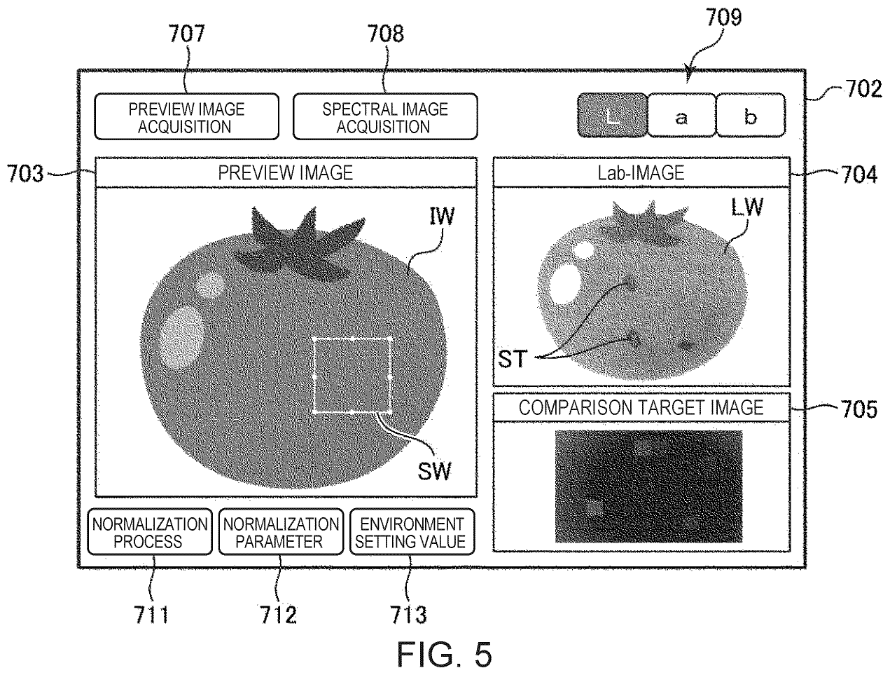

FIG. 5 shows an example of the display screen 702 including a preview image 703 displayed in the preview image acquisition step S102 and an Lab-image 704 displayed in the Lab-image display step S110. In this embodiment, a tomato is illustrated as a target object W.

The display screen 702 shown in FIG. 5 includes the preview image 703, the Lab-image 704, a comparison target image 705, a preview image acquisition button 707, a spectral image acquisition button 708, Lab switch buttons 709, a normalization process button 711, a normalization parameter button 712, and an environment setting value button 713.

In the preview image acquisition process, the measurement control section 204 shown in FIG. 2 controls the operation of the spectroscopic measurement section 3 to acquire the preview image 703 shown in FIG. 5. In the preview image displaying process, the display control section 212 shown in FIG. 2 causes the display section 54 to display the preview image 703. When the preview image acquisition button 707 shown in FIG. 5 is pressed, a preview image acquisition process and a preview image displaying process are executed. Since the acquisition time of the preview image 703 is shorter than that of the spectral image, the preview image 703 represents the appearance of the target object W substantially in real time. Therefore, the user of spectrometer 1 can efficiently perform arrangement of the target object W, distance between the target object W and the spectroscopic measurement section 3, adjustment of the focus, replacement of the lens, adjustment of the light source 62, and the like while viewing the preview image 703.

### 1.2.2. Environment Setting Value Reception Step

In the environment setting value reception step S104, the computer is made to perform an environment setting value reception process.

The environment setting value reception process is a process in which the environment setting value reception section 206 shown in FIG. 2 receives an environment setting value. The environment setting value may be stored in the storage section 56 in advance, or may be input via the input section 52.

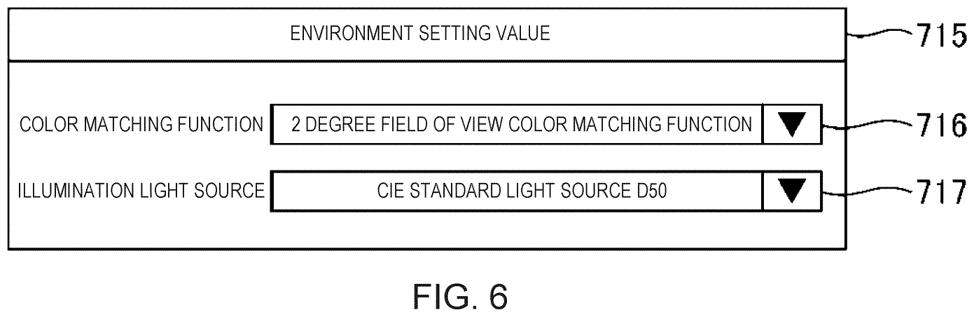

FIG. 6 shows an example of an input screen 715 for supporting input of the environment setting value in the environment setting value reception step S104.

When the environment setting value button 713 shown in FIG. 5 is pressed, the input screen 715 shown in FIG. 6 is displayed on the display section 54. The input screen 715 has a selection field 716 for selecting the type of the color matching function and a selection field 717 for selecting the type of the illumination light source. The selection fields 716 and 717 are pull-down menus, and a desired type can be selected from preset choices.

### 1.2.3. Spectral Image Acquisition Step

In the spectral image acquisition step S106, the computer is caused to perform a spectral image acquisition process.

In the spectral image acquisition process, the measurement control section 204 shown in FIG. 2 controls operation of the spectroscopic measurement section 3 to acquire a spectral image (not shown). When the spectral image acquisition button 708 shown in FIG. 5 is pressed, the spectral image acquisition process is executed. The acquired spectral image is stored in storage section 56.

### 1.2.4. Lab Image Generation Step

In the Lab-image generation step S108, the computer is caused to perform an Lab-image generation process (Lab information generation process).

When the spectral image acquisition button 708 shown in FIG. 5 is pressed, the Lab-image generation process is executed following the spectral image acquisition process, and the Lab-image 704 is generated. The Lab-image generation process is a process in which the Lab information calculation section 208 shown in FIG. 2 generates the Lab-image 704. Specifically, at least one of an L-value, an a-value, and a b-value is extracted for each pixel from the spectral image acquired by the spectral image acquisition process, and visualization is performed. Visualization refers to a process of applying, for example, imaging, graphing, patterning, or the like to Lab-values. In this embodiment, the Lab-values are imaged to generate the Lab-image 704 (Lab visualization information). The Lab-image 704 is an L-image obtained by converting L-values into luminance for each pixel. Note that instead of the L-image, an a-image obtained by converting an a-value into luminance for each pixel or a b-image obtained by converting a b-value into luminance for each pixel may be used. Note that in the Lab-image generation process, the environment setting value stored in the storage section 56 is used.

In the Lab-image 704, any one of the L-image, the a-image, and the b-image is displayed. Further, two or more images may be displayed at the same time. The displayed image is switched by the Lab switch buttons 709 shown in FIG. 5.

Note that the L-value represents lightness in the L*a*b* color space, and the a-value and the b-value represent chromaticity. The a-value represents the chromaticity between red and green in particular, and the b-value represents the chromaticity between yellow and blue. Accordingly, by appropriately selecting any one of the L-image, the a-image, and the b-image, it is possible to generate the Lab-image 704 in which subtle color unevenness is sufficiently emphasized.

In the above preview image acquisition process, when the preview image acquisition button 707 shown in FIG. 5 is pressed, the search window SW shown in FIG. 5 may be displayed together with the preview image 703. By designating the two dimensional region in the preview image 703 using the search window SW, the range of each luminance of the Lab-image 704 can be set in the generation of the Lab-image 704. Each minimum value and each maximum value of the Lab-values in this two dimensional region may be assigned to each minimum value and maximum value of the luminance of the Lab-image 704. The position, size, and shape of the search window SW can be designated using the input section 52. By this, the Lab-image 704 can be generated in a desired luminance range.

Note that instead of the search window SW, each range of the Lab-values may be acquired from the entire preview image 703.

### 1.2.5. Lab-Image Display Step

In the Lab-image display step S110, the computer performs an Lab-image display process (Lab information display process).

The Lab-image display process is a process in which the display control section 212 shown in FIG. 2 displays the Lab-image 704 on the display section 54. The preview image 703 displays a target object IW. The Lab-image 704 shows a target object LW. The color unevenness ST, which is not recognizable in the target object image IW, is reflected in the target object image LW. By displaying the Lab-image 704 in this manner, it is possible to detect color unevenness (color information of the target object W) that cannot be captured by a normal monochrome image or RGB image. By displaying the Lab-image 704 as described above, the color information of the target object W can be displayed so it can be more intuitively understood.

On the display screen 702 shown in FIG. 5, the comparison target image 705 is displayed side by side with the Lab-image 704. The comparison target image 705 is an image stored in advance in the storage section 56 or an image input at an arbitrary timing, and is an image to be compared with the Lab-image 704. By displaying the comparison target image 705 side by side with the Lab-image 704, the user of the spectrometer 1 can easily compare the two images. As a result, since the comparison target image 705 can be used as a color sample, for example, when the user judges whether or not the color information of the color unevenness ST should be rejected, it is possible to support an accurate judgment.

### 1.2.6. Normalization Process Step

In the normalization process step S112, the computer is made to perform the normalization process. This step can be performed as necessary, for example, when the Lab-image 704 generated by the Lab-image generation process is not appropriate.

The normalization process in this step is a process in which the normalization process section 210 shown in FIG. 2 normalizes the range of each luminance of the Lab-image based on the normalization parameter. By this, a desired value is set in each range of the Lab-values.

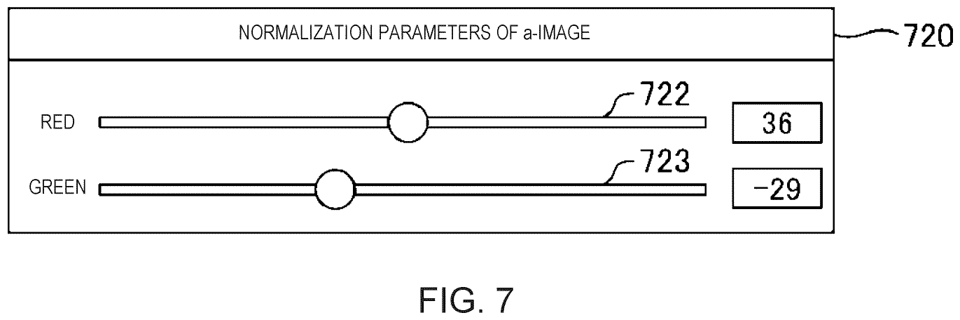

FIG. 7 shows an example of an input screen 720 for supporting input of normalization parameters in the normalization process step S112.

When the normalization parameter button 712 shown in FIG. 5 is pressed, the input screen 720 shown in FIG. 7 is displayed on the display section 54. The input screen 720 has, for example, sliders 722 and 723 for accepting specified values of the normalization parameters of the a-image. The maximum value of the a-value can be designated by sliding the slider 722 via the input section 52 and the minimum value of the a-value can be designated by sliding the slider 723.

After specifying the normalization parameters, when the normalization process button 711 shown in FIG. 5 is pressed, the normalization process is executed. By this, the range of each luminance of the Lab-image is updated based on the normalization parameter. Then, the updated Lab-image 704 is displayed in FIG. 5. By updating the Lab-image 704, the resolution of the luminance can be further enhanced and, for example, the color unevenness ST shown in FIG. 5 can be displayed more clearly.

Note that the input method of the normalization parameters is not limited to the above. For example, the search window SW may be changed to redesignate the two dimensional region, or the specified values may be input by text. The former performs normalization process based on each range of Lab-values in a two dimensional region. The latter performs a normalization process based on specified values entered in text. By this, the normalization process can be performed as intended, and the Lab-image 704 with sufficiently enhanced luminance resolution can be obtained.

Although the spectroscopic measurement result display method according to the first embodiment has been described above, some of the steps described above may be omitted, or similar steps may be substituted.

The order of the steps may be reversed.

### 2. Modification of the First Embodiment

Next, a modification of the first embodiment will be described.

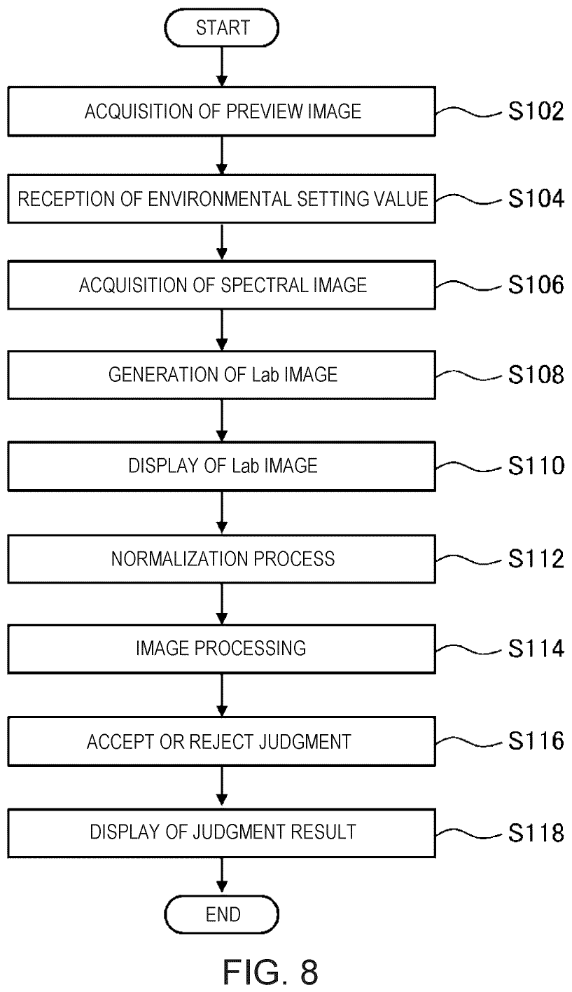

FIG. 8 is a flow chart showing a configuration of a spectroscopic measurement result display method according to a modification of the first embodiment.

Hereinafter, a modification of the first embodiment will be described, but in the following description, the description will center on differences from the first embodiment, and description of similar items will be omitted. Note that in each of the drawings, the same components as those in FIGS. 1 to 7 are denoted by the same reference numerals.

The modification example of the first embodiment is the same as the first embodiment except that the accept or reject judgment of the color information of the target object W is performed based on the generated Lab-image.

The spectroscopic measurement result display method shown in FIG. 8 includes a preview image acquisition step S102, an environment setting value reception step S104, a spectral image acquisition step S106, an Lab-image generation step S108, an Lab-image display step S110, a normalization process step S112, an image processing step S114, an accept or reject judgment step S116, and a judgment result display step S118.

### 2.1. Preview Image Acquisition Step

In the preview image acquisition step S102, the computer is caused to perform a preview image acquisition process and a preview image displaying process.

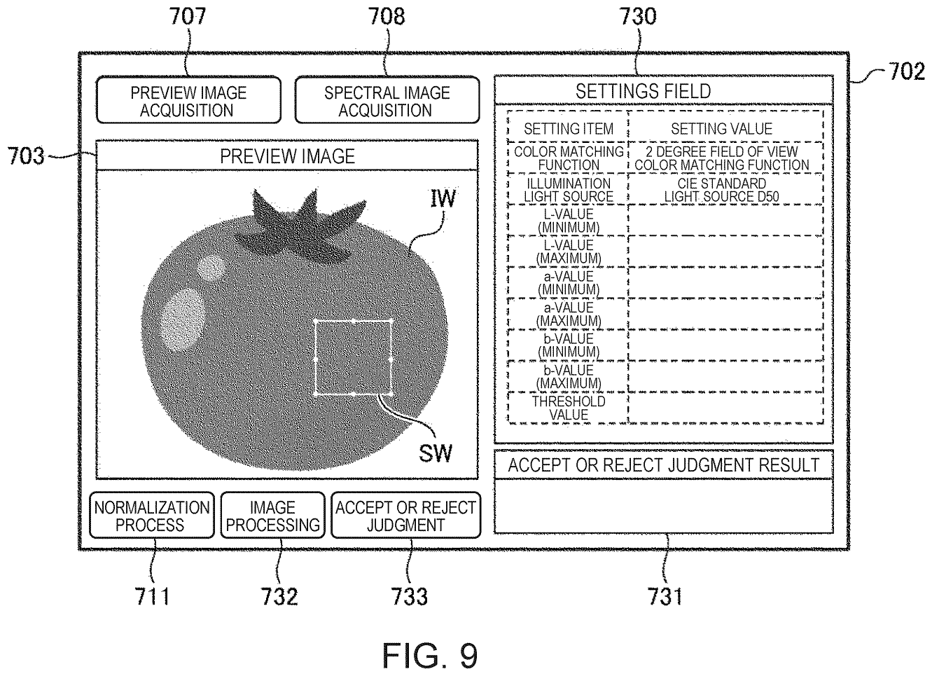

FIG. 9 shows an example of the display screen 702 including the settings field 730 and the preview image 703 displayed in the preview image acquisition step S102 in the modification of the first embodiment.

The display screen 702 shown in FIG. 9 has the preview image 703, the preview image acquisition button 707, the spectral image acquisition button 708, the normalization process button 711, a settings field 730, an accept or reject judgment result 731, an image processing button 732, and an accept or reject judgment button 733.

### 2.2. Environment Setting Value Reception Step

In the environment setting value reception step S104, the computer is made to perform an environment setting value reception process.

In the settings field 730 shown in FIG. 9, input of a setting value for each setting item is received. The setting items include, for example, an environment setting value such as a color matching function and an illumination light source, a normalization parameter such as a minimum L-value, a maximum L-value, a minimum a-value, a maximum a-value, a minimum b-value, and a maximum b-value, various threshold values, and the like. The environment setting value and normalization parameter are stored in the storage section 56.

### 2.3. Spectral Image Acquisition Step

In the spectral image acquisition step S106, the computer is caused to perform a spectral image acquisition process.

### 2.4. Lab Image Generation Step

In the Lab-image generation step S108, the computer is caused to perform an Lab-image generation process (Lab information generation process).

The Lab-image generation process generates an Lab-image (Lab visualization information) based on the environment setting value and the normalization parameter stored in the storage section 56. Note that as the normalization parameters, each range of the Lab-value in the two dimensional region designated by the search window SW shown in FIG. 9 may be used, or the specified values of the Lab-value input in the settings field 730 shown in FIG. 9 may be used.

### 2.5. Lab-Image Display Step

In the Lab-image display step S110, the computer performs an Lab-image display process (Lab information display process).

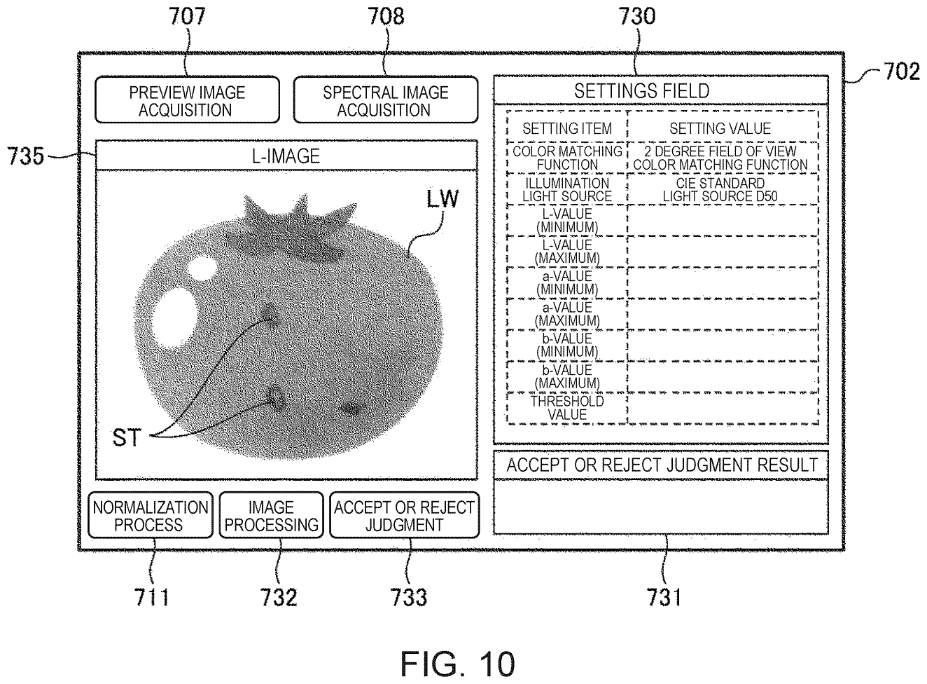

FIG. 10 shows an example of the display screen 702 including the L image 735 displayed in the Lab-image display step S110 in the modification example of the first embodiment.

The L image 735 shown in FIG. 10 is an example of the Lab-image. When the spectral image acquisition button 708 shown in FIG. 9 is pressed, the spectral image acquisition process and the Lab-image generation process are executed, and transition is made from the preview image 703 to the L image 735. Note that in FIG. 10, a switching button (not shown) is provided so that one or more of the L-image, the a-image, and the b-image can be selected and displayed.

### 2.6. Normalization Process Step

In the normalization process step S112, the computer is made to perform the normalization process. This step can be performed as necessary, for example, when the Lab-image 704 generated by the Lab-image generation process is not appropriate.

On the display screen 702 shown in FIG. 10, the L image 735 and the settings field 730 (input reception screen) for receiving input of normalization parameters are arranged side by side. By this, it is possible to input more appropriate normalization parameters while observing the change of the L image 735.

### 2.7. Image Processing Step

In the image processing step S114, image processing is performed by the computer. Note that the image processing step S114 may be performed as necessary, or may be omitted.

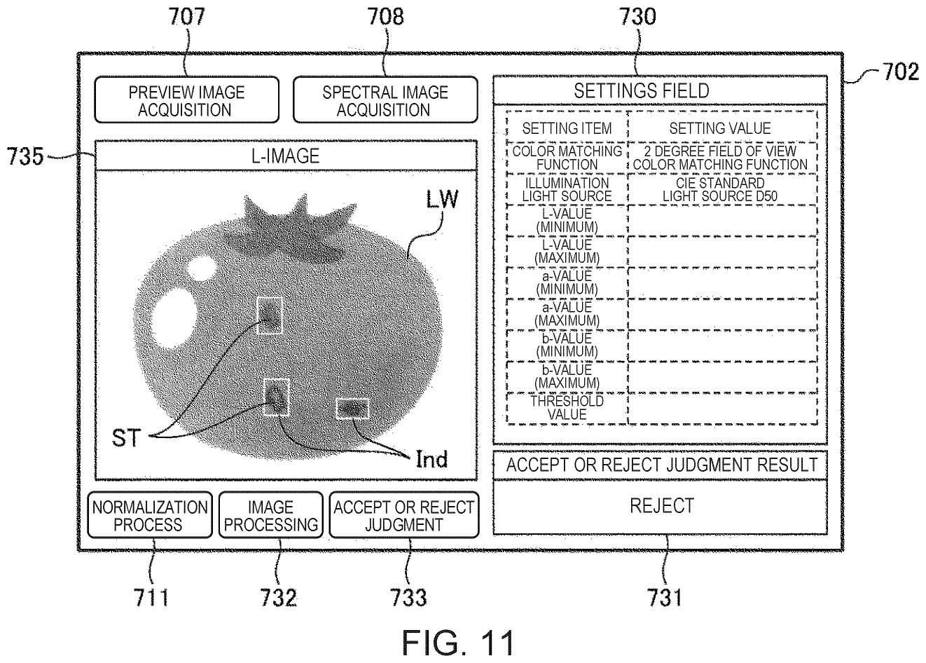

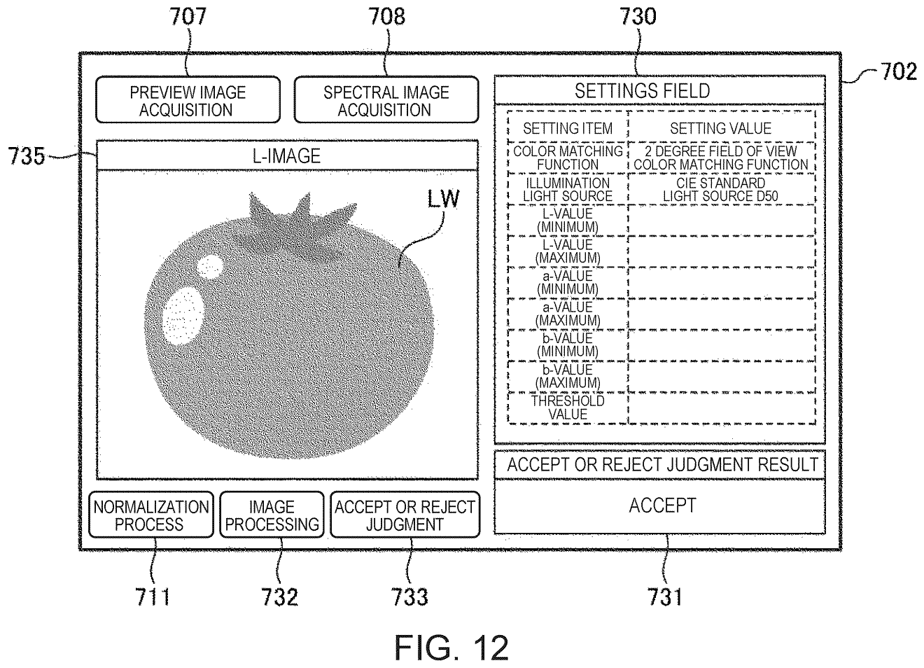

FIG. 11 and FIG. 12 are each an example of the display screen 702 including the L image 735 after image processing is performed in the image processing step S114.

When the image processing button 732 shown in FIG. 10 is pressed, image processing is performed on the L image 735. Image processing is not particularly limited, and examples thereof include a binarization process, a blob detection process, and the like.

In the binarization process, the luminance of each pixel of the L image 735 is binarized based on a preset threshold value. By binarization, the color unevenness ST included in the L image 735 is emphasized. Note that instead of the binarization process, an arbitrary process for increasing the contrast between the color unevenness ST and the other portions may be used.

In the blob detection process, based on a preset threshold value, a blob is detected in the L image 735 or in the L image 735 that was subjected to high-contrast processing such as a binarization process. The area occupied by the color unevennesses ST can be specified by the blob detection. By this, the size of the color unevennesses ST can be quantitatively evaluated. FIG. 11 includes indicators Ind indicating a range detected as a blob by the blob detection process.

### 2.8. Accept or Reject Judgment Step

In the accept or reject judgment step S116, the computer performs an accept or reject judgment.

When the accept or reject judgment button 733 shown in FIG. 11 is pressed, the accept or reject judgment is performed on the L image 735 that was subjected to image processing. The accept or reject judgment is performed, for example, based on the size and number of the indicators Ind shown in FIG. 11. When the size or number of the indicators Ind satisfies the threshold value, it is judged to be acceptable. For example, no indicator Ind is shown in FIG. 12. Therefore, it can be judged that the L image 735 shown in FIG. 12 is acceptable. On the other hand, when the size or number of the indicator Ind does not satisfy the threshold value, it is judged to be a reject.

### 2.9. Judgment Result Display Step

In the judgment result display step S118, the computer performs a judgment result display process.

When the accept or reject judgment is performed in the accept or reject judgment step S116, characters and the like representing the accept or reject judgment result are displayed in the accept or reject judgment result 731 shown in FIG. 11 and FIG. 12. For example, in FIG. 11, “reject” is displayed, and in FIG. 12, “acceptable” is displayed. By performing the accept or reject judgment based on the L image 735 in this manner, it is possible to more accurately inspect the color information of the target object W.

In the above-described modification, the same effects as those of the first embodiment can be obtained.

### 3. Second Embodiment

Next, a second embodiment will be described.

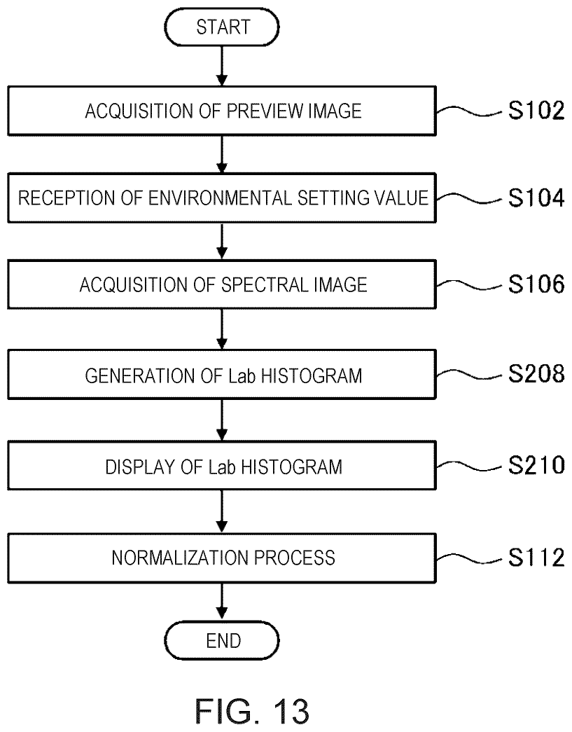

FIG. 13 is a flow chart showing the configuration of a spectroscopic measurement result display method according to a second embodiment.

The second embodiment will be described below, but in the following description, the description will center on differences from the first embodiment, and description of similar items will be omitted. Note that in each of the drawings, the same components as those in FIGS. 1 to 7 are denoted by the same reference numerals.

The second embodiment is the same as the first embodiment except that an Lab histogram is generated and displayed as Lab visualization information.

### 3.1. Preview Image Acquisition Step

In the preview image acquisition step S102, the computer is caused to perform a preview image acquisition process and a preview image displaying process.

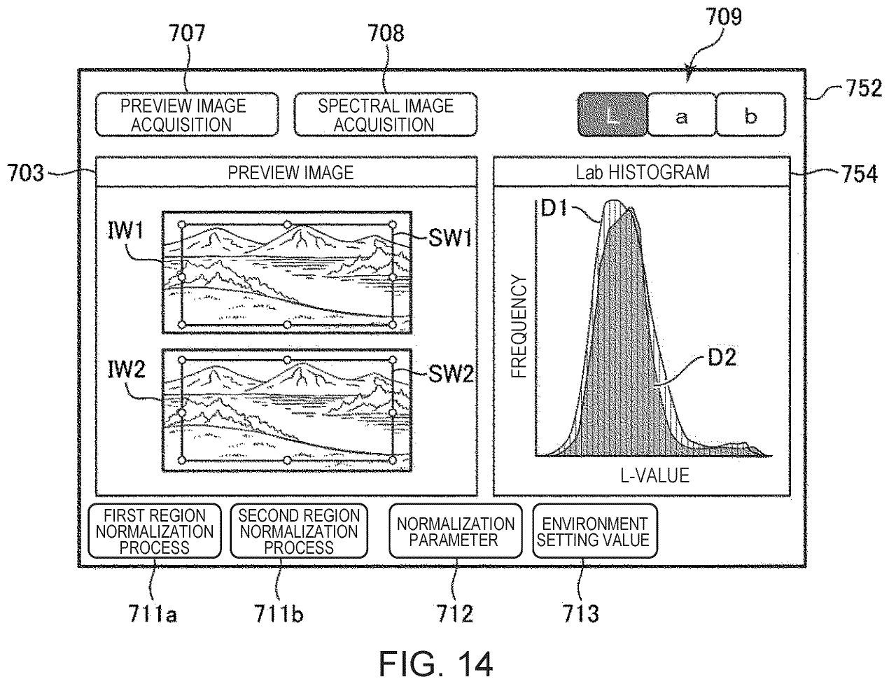

FIG. 14 shows an example of the display screen 752 including the preview image 703 displayed in the preview image acquisition step S102 and an Lab histogram 754 displayed in an Lab histogram display step S210 in the second embodiment. In this embodiment, two landscape photographs (color photographs) having slightly different colors are shown as the target object W.

The display screen 752 shown in FIG. 14 has the preview image 703, the Lab histogram 754, the preview image acquisition button 707, the spectral image acquisition button 708, a first region normalization button 711a, a second region normalization button 711b, the normalization parameter button 712, and the environment setting value button 713.

### 3.2. Environment Setting Value Reception Step

In the environment setting value reception step S104, the computer is made to perform an environment setting value reception process.

### 3.3. Spectral Image Acquisition Step

In the spectral image acquisition step S106, the computer is caused to perform a spectral image acquisition process.

### 3.4. Lab Histogram Generation Step

In the Lab histogram generation step S208, the computer performs an Lab histogram generation process (Lab information generation process).

When the spectral image acquisition button 708 shown in FIG. 14 is pressed, the spectral image acquisition process and the Lab histogram generation process are executed, and the Lab histogram 754 is generated. The Lab histogram generation process is a process in which the Lab information calculation section 208 shown in FIG. 2 generates the Lab histogram 754. In this embodiment, the Lab-values are graphed to generate an Lab histogram 754 (Lab visualization information). The Lab histogram 754 is an L-histogram obtained by graphing the frequency of the L-value for each bin. Note that instead of an L-histogram, an a-histogram obtained by graphing the frequency of a-values for each bin, or a b-histogram obtained by graphing the frequency of b-values for each bin may be used. Note that in the following description, at least one of the L-histogram, the a-histogram, and the b-histogram is also referred to as an Lab histogram. By generating such an Lab histogram 754 and displaying it in the Lab histogram display step S210 (to be described later), it is possible to display the color information of the target object W so it can be more intuitively understood. Note that in the Lab histogram generation process, the environment setting value stored in the storage section 56 is used.

In the Lab histogram 754, any one of an L-histogram, an a-histogram, and a b-histogram is displayed. Note that two or more images may be displayed at the same time. The displayed histogram is switched by the Lab switch buttons 709 shown in FIG. 14.

In the above preview image acquisition process, when the preview image acquisition button 707 shown in FIG. 14 is pressed, the two search windows SW1 and SW2 shown in FIG. 14 may be displayed together with the preview image 703. By designating a two dimensional region in the preview image 703 using the search windows SW1 and SW2, the range of each bin of the Lab histogram 754 can be set in the generation of the Lab histogram 754. Specifically, each minimum value and each maximum value of the Lab-values in this two dimensional region may be assigned to each minimum value and each maximum value of the bins of the Lab histogram 754. The position, size, and shape of search windows SW1 and SW2 can be designated via the input section 52. By this, the Lab histogram 754 can be generated in the desired bin ranges.

Note that instead of the search windows SW1 and SW2, the respective ranges of Lab-values may be acquired from the entire preview image 703.

### 3.5. Lab Histogram Display Step

In the Lab histogram display step S210, the computer performs an Lab histogram display process (Lab information display process).

The Lab histogram display process is a process in which the display control section 212 shown in FIG. 2 displays the Lab histogram 754 on the display section 54. The preview image 703 shows the target objects IW1 and IW2. The Lab histogram 754 includes graph data D1 and D2 corresponding to the target objects IW1 and IW2, respectively. By displaying the Lab histogram 754 in this way, it is possible to more accurately detect the difference in the color information of the target object W, and to display the difference in the detected color information so it can be more intuitively understood. Since the graph data D1 and D2 is displayed at the same time, for example, the graph data D1 serving as a color sample can be compared with the graph data D2 serving as a measurement target. By this, accurate color inspection can be performed on the target object IW2.

### 3.6. Normalization Process Step

In the normalization process step S112, the computer is made to perform the normalization process. This step can be performed as necessary, for example, when the Lab histogram 754 generated by the Lab histogram generation process is not appropriate.

When the normalization parameter button 712 shown in FIG. 14 is pressed, normalization parameters can be designated, for example, in the same manner as in the first embodiment. Note that the normalization parameters can be individually set for the search windows SW1 and SW2.

Next, either the first region normalization button 711a or the second region normalization button 711b shown in FIG. 14 is pressed. When the first region normalization button 711a is pressed, a normalization process for normalizing the range of each bin of the Lab histogram 754 is executed based on the normalization parameters set for the search window SW1. When the second region normalization button 711b is pressed, a normalization process for normalizing the range of each bin of the Lab histogram 754 is executed based on the normalization parameters set for the search window SW2. By this, the range of each bin of the Lab histogram 754 is updated based on the normalization parameters. The updated Lab histogram 754 is displayed in FIG. 14. By updating the Lab histogram 754, the frequency resolution can be further enhanced, and the graph data D1 and D2 can be compared more accurately.

Note that the input method of the normalization parameters is not limited to the above. For example, the search windows SW1 and SW2 may be changed to redesignate the two dimensional region, or the specified values may be input using text. By this, the normalization process can be performed as intended, and the Lab histogram 754 with sufficiently high frequency resolution can be obtained.

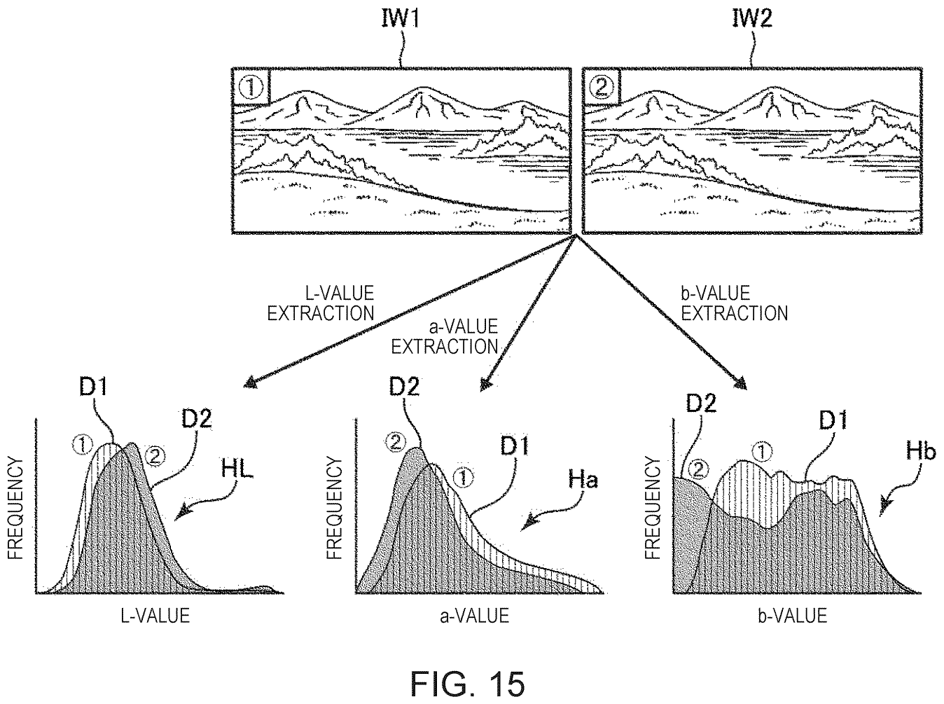

FIG. 15 is a conceptual diagram showing an example of a difference between an L-histogram HL, an a-histogram Ha, and a b-histogram Hb.

The target objects IW1 and IW2 shown in FIG. 15 are substantially the same except for a slight difference in color. These spectral images are acquired, and the Lab-values are extracted to generate the L-histogram HL, the a-histogram Ha, and the b-histogram Hb. In each histogram, the graph data D1 generated from the target object IW1 and the graph data D2 generated from the target object IW2 are superimposed and displayed.

Comparing the three histograms, the differences between the graph data D1 and D2 are relatively small in both the L-histogram HL and the a-histogram Ha. On the other hand, in the b-histogram Hb, the difference between the graph data D1 and D2 is large. In this way, by displaying two or more histograms and comparing the graph data, it is possible to more accurately compare the color information of the target objects IW1 and IW2. In particular, the a-values and b-values, which represent chromaticity, can be negative or positive. For this reason, even if the mean values of the a-values and the b-values are calculated and used for comparison, the negative values and the positive values may cancel each other out, and the comparison may not be appropriate. On the other hand, since the above-mentioned cancellation does not occur by comparing using a histogram, an appropriate comparison can be performed.

Although the spectroscopic measurement result display method according to the second embodiment has been described above, a part of each step described above may be omitted, or steps having the same configuration may be substituted. The order of the steps may be reversed.

### 4. Modification of Second Embodiment

Next, a modification of the second embodiment will be described.

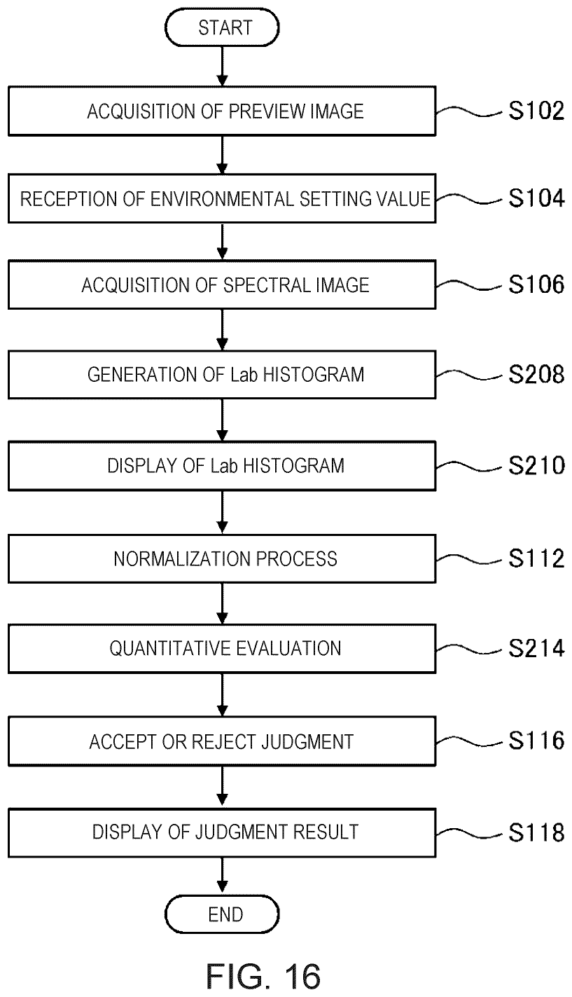

FIG. 16 is a flow chart showing configuration of a spectroscopic measurement result display method according to a modification of the second embodiment.

Hereinafter, the modification of the second embodiment will be described, but in the following description, description will center on differences from the first and second embodiments, and description of similar items will be omitted. Noter that in the figures, the same components as those in FIGS. 1 to 15 are denoted by the same reference numerals.

A modification example of the second embodiment is the same as the second embodiment except that the accept or reject judgment of the color information of the target object W is performed based on the generated Lab histogram.

The spectroscopic measurement result display method shown in FIG. 16 includes the preview image acquisition step S102, the environment setting value reception step S104, the spectral image acquisition step S106, the Lab histogram generation step S208, the Lab histogram display step S210, the normalization process step S112, a quantitative evaluation step S214, the accept or reject judgment step S116, and the judgment result display step S118.

### 4.1. Preview Image Acquisition Step

In the preview image acquisition step S102, the computer is caused to perform a preview image acquisition process and a preview image displaying process.

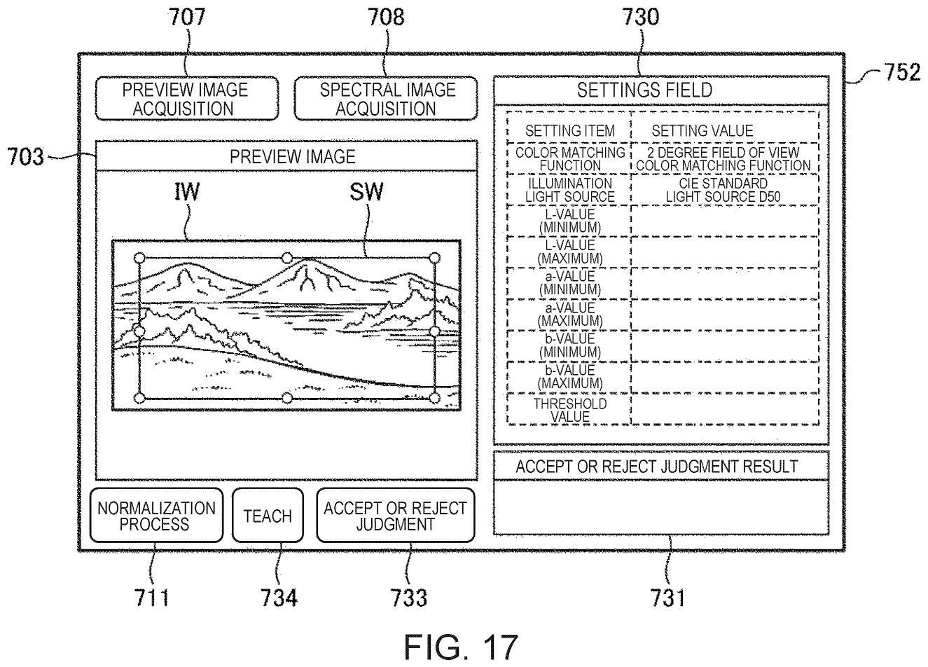

FIG. 17 shows an example of the display screen 752 including the preview image 703 and the settings field 730 displayed in the preview image acquisition step S102 in the modification of the second embodiment.

The display screen 752 shown in FIG. 17 has the preview image 703, the preview image acquisition button 707, the spectral image acquisition button 708, the normalization process button 711, the settings field 730, the accept or reject judgment result 731, a teach button 734, and the accept or reject judgment button 733.

### 4.2. Environment Setting Value Reception Step

In the environment setting value reception step S104, the computer is made to perform an environment setting value reception process.

Input of a setting value for each setting item is received in settings field 730 shown in FIG. 17. The setting items include, for example, an environment setting value like a color matching function and an illumination light source, and a normalization parameter such as a minimum L-value, a maximum L-value, a minimum a-value, a maximum a-value, a minimum b-value, and a maximum b-value. The environment setting value and normalization parameter are stored in the storage section 56.

### 4.3. Spectral Image Acquisition Step

In the spectral image acquisition step S106, the computer is caused to perform a spectral image acquisition process.

### 4.4. Lab Histogram Generation Step

In the Lab histogram generation step S208, the computer performs an Lab histogram generation process (Lab information generation process).

In the process of generating the Lab histogram 754, an Lab histogram (Lab visualization information) is generated based on the environment setting value and the normalization parameter stored in the storage section 56. Note that as normalization parameters, each range of Lab-values in the two dimensional region designated by the search window SW shown in FIG. 17 may be used, or the specified values of the Lab-values that were input in the settings field 730 shown in FIG. 17 may be used. Note that when the Lab histogram 754 is a distribution close to a normal distribution, a value corresponding to the ±3σ of the normal distribution may be adopted as the specified values of the Lab-values. σ is the standard deviation of the normal distribution.

### 4.5. Lab Histogram Display Step

In the Lab histogram display step S210, the computer performs an Lab histogram display process (Lab information display process).

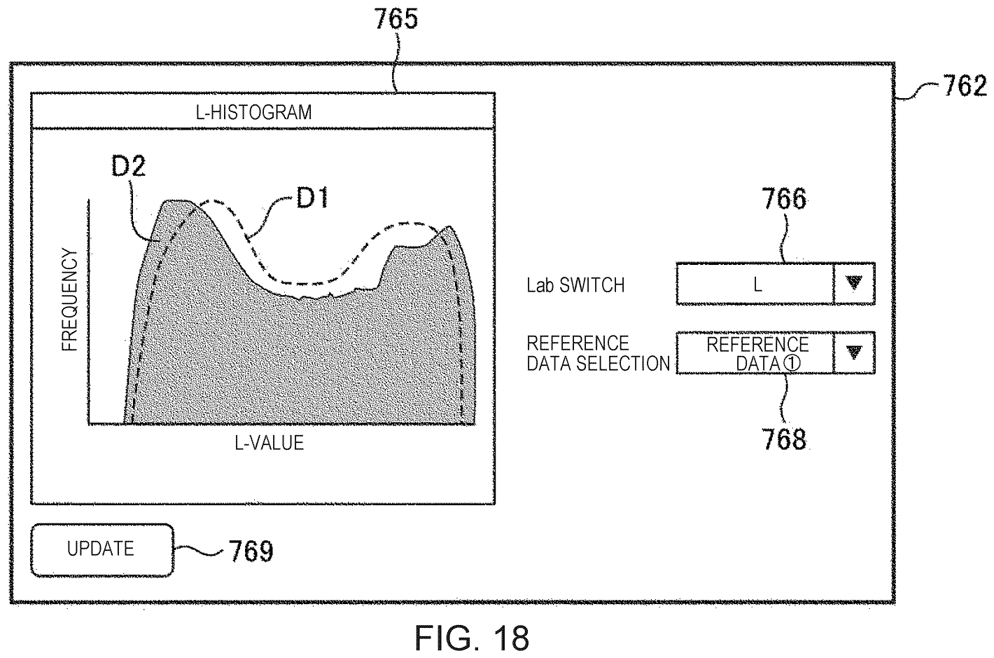

FIG. 18 shows an example of a display screen 762 including the L-histogram 765 displayed in the Lab histogram display step S210 in the modification of the second embodiment.

The L-histogram 765 shown in FIG. 18 is an example of an Lab histogram. When the spectral image acquisition button 708 shown in FIG. 17 is pressed, the spectral image acquisition process and the Lab histogram generation process are executed. Thereafter, when a histogram display button (not shown) is pressed, a display screen 762 shown in FIG. 18 is displayed. The display screen 762 shown in FIG. 18 has an Lab switch field 766, a reference data selection field 768, and an update button 769. The Lab switch field 766 is a pull-down menu, and it is possible to select any one of an L-histogram, an a-histogram, or a b-histogram. The reference data selection field 768 allows for the selection of the type of reference data. After selecting the histogram type and the reference data type, when the update button 769 is pressed, the graph data D1 and D2 displayed in the L-histogram 765 is updated and displayed. By this, for example, the graph data D1 based on the reference data and the graph data D2 based on the measurement data of the target object W can be superimposed and compared. As a result, accurate color inspection can be performed on the target object image IW.

### 4.6. Normalization Process Step

In the normalization process step S112, the computer is made to perform the normalization process. This step can be performed as necessary, for example, when the Lab histogram 754 generated by the Lab histogram generation process is not appropriate.

### 4.7. Quantitative Evaluation Step

In the quantitative evaluation step S214, the computer performs quantitative evaluation.

When the teach button 734 shown in FIG. 17 is pressed, a teaching screen (not shown) is displayed. Reference data used for quantitative evaluation can be registered using the teaching screen. Reference data is data serving as a reference for the accept or reject judgment, and is used for quantitative evaluation of the relationship between the measurement data of the target object W and the reference data. A list of reference data may be displayed so as to be selectable on the teaching screen. At this time, a pseudo color, a thumbnail image, an average Lab-value, a threshold value for accept or reject judgment, and the like of each set of data may be displayed in the list. On the teaching screen, the reference data to be used for quantitative evaluation of the measurement data is selected.

Quantitative evaluation includes, for example, an evaluation based on a correlation coefficient between the reference data and the measurement data (first evaluation), an evaluation based on an error ratio between the reference data and the measurement data (second evaluation), and an evaluation based on a comparison between a Mahalanobis distance from acceptance data to measurement data and a Mahalanobis distance from rejection data to measurement data (third evaluation).

In the first evaluation, the frequency of each bin obtained from the spectral image is set as measurement data, and the frequency of the reference set for each bin is set as reference data. The ratio of the measurement data to the reference data is then calculated for each bin. Also, the correlation coefficient of the distribution of the obtained ratio is calculated, and the quantitative evaluation is performed based on the calculated correlation coefficient. By such a quantitative evaluation, the color inspection (to be described later) can be performed with high accuracy.

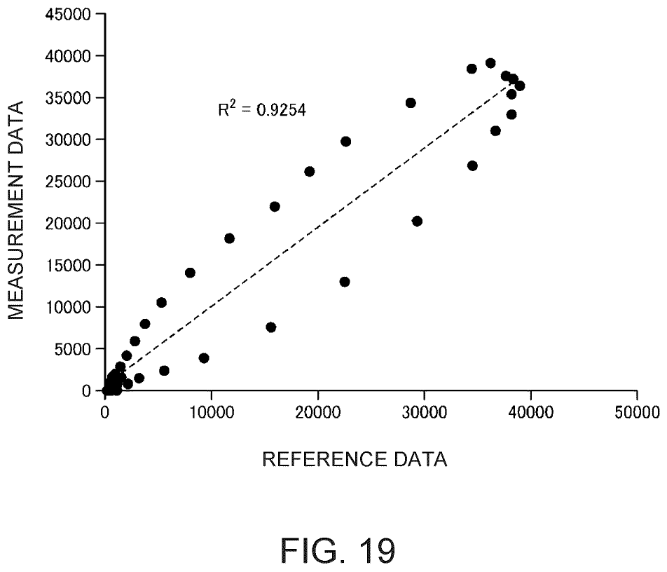

FIG. 19 is a scatter diagram obtained by plotting the reference data and the measurement data, and a graph showing a regression line obtained by linearly approximating the plot marks. A determination coefficient R2 can be calculated by finding the regression line of the plot mark as shown in FIG. 19. The determination coefficient is the square of the correlation coefficient, with values closer to 1 quantitatively indicating that the measurement data is closer to the reference data. Note that although FIG. 19 shows a graph for L-values, a graph for a-values or b-values may be created. In these cases, maximum value, minimum value, and mean value of the correlation coefficient may be calculated from two or more graphs, and the quantitative evaluation may be performed based on the calculation results.

In the second evaluation, the frequency of each bin obtained from the spectral image is set as measurement data, and the frequency of the reference set for each bin is set as reference data. Next, the error ratio between the reference data and the measurement data is calculated. Then, the quantitative evaluation is performed based on the calculated error ratio. By such a quantitative evaluation, the color inspection (to be described later) can be performed with high accuracy.

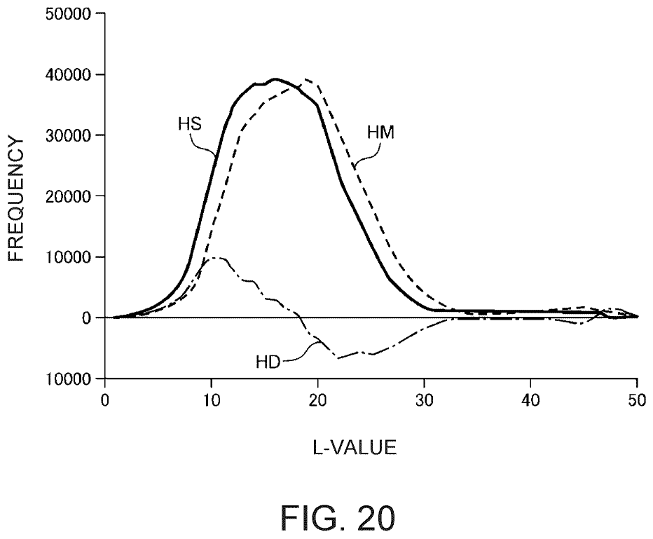

FIG. 20 is a graph HS of reference data, a graph HM of measurement data, and a graph HD of the difference obtained by subtracting the graph HM from the graph HS. First, the difference values are squared for each bin of L-values in the graph HD, the sum is taken, and then the square root is taken. Then, the calculation result is used as an error ratio. The smaller the value of the error ratio, the closer the measurement data is to the reference data. Note that although a graph of L-values is shown in FIG. 20, a graph of a-values or b-values may be created. In this case, the maximum value, minimum value, and mean value of the error ratio may be calculated from two or more graphs, and the quantitative evaluation may be performed based on the calculation results.

In the third evaluation, the frequency of each bin obtained from the spectral image is set as measurement data, the frequency of acceptance set for each bin is set as acceptance data, and the frequency of rejection set for each bin is set as rejection data. Therefore, the measurement data acquired from the target object W judged to be acceptable by another method, for example, is used as the acceptance data, and the measurement data acquired from the target object W that was judged to be a reject by another method, for example, is used as the rejection data. Next, quantitative evaluation is performed based on a comparison between the Mahalanobis distance from acceptance data to measurement data and the Mahalanobis distance from rejection data to measurement data. By such a quantitative evaluation, the color inspection (to be described later) can be performed with high accuracy.

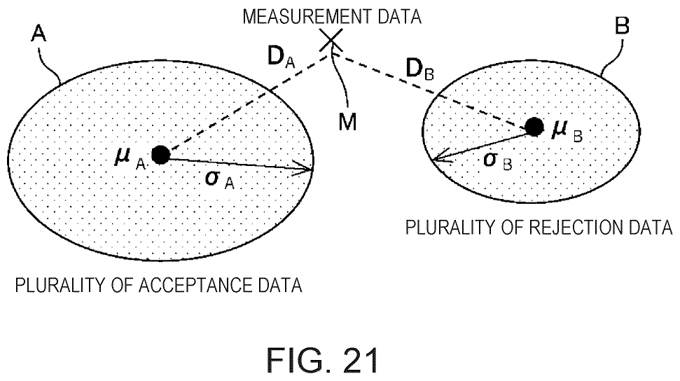

FIG. 21 is a conceptual diagram showing the distances between a range A occupied by a plurality of acceptance data, a range B occupied by a plurality of rejection data, and measurement data M. FIG. 21 shows, with respect to an arbitrary bin, the mean value HA and the standard deviation σ_{A} of a plurality of acceptance data and the Mahalanobis distance D_{A} between the measurement data and the acceptance data. The Mahalanobis distance D_{A} is defined by, for example, a value obtained by dividing the difference between the measurement data M and the mean value μ_{A} by the standard deviation σ_{A}. FIG. 21 shows, with respect to an arbitrary bin, the mean value μB and the standard deviation σB of a plurality of rejection data, and the Mahalanobis distance D_{B} between the measurement data and the rejection data. The Mahalanobis distance D_{B} is defined by, for example, a value obtained by dividing the difference between the measurement data M and the mean value μ_{B} by the standard deviation σ_{B}. When the Mahalanobis distance D_{A} and the Mahalanobis distance D_{B} satisfy D_{A}<D_{B}, the measurement data M can be regarded as being close to the acceptance data range A, and when D_{B}<D_{A} is satisfied, the measurement data M can be regarded as being close to the rejection data range B.

### 4.8. Accept or Reject Judgment Step

In the accept or reject judgment step S116, the computer performs an accept or reject judgment.

When the accept or reject judgment button 733 shown in FIG. 17 is pressed, accept or reject judgment based on the relationship between the threshold value and the evaluation result of the quantitative evaluation is executed. If the evaluation result of the quantitative evaluation satisfies the threshold value, it is judged as acceptable. If the evaluation result of the quantitative evaluation does not satisfy the threshold value, it is judged to be a reject. In this way, color inspection based on a threshold value can be performed.

### 4.9. Judgment Result Display Step

In the judgment result display step S118, the computer performs a judgment result display process.

When the accept or reject judgment is performed in the accept or reject judgment step S116, characters and the like representing the accept or reject judgment result are displayed in the accept or reject judgment result 731 shown in FIG. 17. By performing the accept or reject judgment based on an Lab histogram in this manner, the color information of the target object W can be inspected more accurately.

In the above-described modification, the same effects as those of the second embodiment can be obtained.

### 5. Effects of the Above Embodiments

As described above, spectrometer 1 according to the above embodiments includes the spectroscopic measurement section 3, the display section 54, and the control section 2. The spectroscopic measurement section 3 performs spectroscopic measurement of the target object W and acquires a spectral image. The control section 2 generates Lab visualization information (Lab-image 704 or Lab histogram 754) from the spectral image, and causes the display section 54 to display the Lab visualization information.

According to such a configuration, it is possible to obtain the spectrometer 1 that more accurately detects the color information of the target object W and that displays the detected color information in a way in which it can be intuitively understood.

In the spectrometer 1 according to the above embodiments, the Lab visualization information is an L-image obtained by converting an L-value into luminance for each pixel, an a-image obtained by converting an a-value into luminance for each pixel, or a b-image obtained by converting a b-value into luminance for each pixel.

According to such a configuration, it is possible to obtain the spectrometer 1 capable of generating and displaying an Lab-image in which subtle color unevenness is sufficiently emphasized.

In the spectrometer 1 according to the above embodiments, the control section 2 sets the range of each luminance of the L-image, the a-image, or the b-image based on each range of the extracted L-values, a-values, or b-values.

According to such a configuration, it is possible to obtain the spectrometer 1 capable of generating the Lab-image 704 in a desired luminance range.

In the spectrometer 1 according to the above embodiments, the control section 2 has an image processing section 216. The image processing section 216 performs a binarization process on the L-image, the a-image, or the b-image, and then performs a blob detection process on the L-image, the a-image, or the b-image that was subjected to the binarization process.

According to such a configuration, for example, the area occupied by color unevenness ST can be specified. By this, the spectrometer 1 capable of quantitatively evaluating the size of the color unevenness ST is obtained.

In the spectrometer 1 according to the above embodiments, the Lab visualization information is an L-histogram obtained by graphing the frequency of L-values for each bin, an a-histogram obtained by graphing the frequency of a values for each bin, or a b-histogram obtained by graphing the frequency of b values for each bin.

According to such a configuration, it is possible to obtain the spectrometer 1 capable of more accurately detecting the difference in the color information of the target object W and displaying the difference in the detected color information so it can be more intuitively understood.

In the spectrometer 1 according to the above embodiments, the control section 2 sets the range of each bin of the L-histogram, a-histogram, or b-histogram based on each range of the extracted L-values, a-values, or b-values.

According to such a configuration, it is possible to obtain the spectrometer 1 capable of generating the Lab histogram 754 in a desired bin range.

In the spectrometer 1 according to the above embodiments, when the frequency of each bin obtained from the spectral image is used as the measurement data and the frequency of the reference set for each bin is used as the reference data, the control section 2 may include an accept or reject judgment section 218 that calculates the ratio of the measurement data to the reference data for each bin and makes an accept or reject judgment for measurement data based on the correlation coefficient of the distribution of the obtained ratio.

According to such a configuration, the color inspection of the target object W can be performed with high accuracy.

In the spectrometer 1 according to the above embodiments, when the frequency of each bin obtained from the spectral image is used as the measurement data and the frequency of the reference set for each bin is used as the reference data, the control section 2 may include an accept or reject judgment section 218 that calculates the error ratio between the reference data and the measurement data and makes an accept or reject judgment for the measurement data based on the error ratio.

According to such a configuration, the color inspection of the target object W can be performed with high accuracy.

In the spectrometer 1 according to the above embodiments, when the frequency of each bin obtained from the spectral image is the measurement data, the frequency of acceptance set for each bin is the acceptance data, and the frequency of rejection set for each bin is the rejection data, then the control section 2 may have an accept or reject judgment section 218 for judging acceptance or rejection of the measurement data based on the Mahalanobis distance from the acceptance data to the measurement data and the Mahalanobis distance from the rejection data to the measurement data.

According to such a configuration, the color inspection of the target object W can be performed with high accuracy.

The spectrometer 1 according to the above embodiments includes an input section 52. Also, the control section 2 may include a normalization process section 210 for acquiring, as each range described above, each range of the L-values, the a-values, or the b-values in the two dimensional region input via the input section 52.

According to such a configuration, the normalization process can be performed as intended based on each range of the Lab-values in the two dimensional region.

The spectrometer 1 according to the above embodiments includes an input section 52. Also, the control section 2 may include a normalization process section 210 for acquiring, as each of the ranges described above, the specified values input by the input section 52.

According to this configuration, the normalization process can be performed as intended based on the specified values.

In the spectrometer 1 according to the above embodiments, the control section 2 includes a display control section 212. The display control section 212 causes the display section 54 to display the L image 735 (Lab visualization information) and the settings field 730 (input reception screen) for receiving the input of the specified values side by side.

According to such a configuration, it is possible to input more appropriate specified values (normalization parameter) while observing the change of the L image 735.

In the spectrometer 1 according to the above embodiments, the control section 2 has an environment setting value reception section 206 and an Lab information calculation section 208. The environment setting value reception section 206 receives an environment setting value including at least one of a color matching function and an illumination light source. The Lab information calculation section 208 generates Lab visualization information (Lab-image 704 or Lab histogram 754) based on the spectral image and the environment setting value.

According to such a configuration, Lab visualization information obtained by extracting color information of the target object W with higher accuracy can be obtained.

The spectroscopic measurement result display method according to the above embodiments is a method for displaying the spectroscopic measurement result of the target object W on the display section 54, and has a spectral image acquisition step S106, an Lab-image generation step S108 or an Lab histogram generation step S208, and an Lab-image display step S110 or an Lab histogram display step S210. In the spectral image acquisition step S106, a spectral image of the target object W is acquired. In the Lab-image generation step S108 and the Lab histogram generation step S208, Lab visualization information (Lab-image 704 or Lab histogram 754) is generated from the spectral image. In the Lab-image display step S110 and the Lab histogram display step S210, the Lab visualization information is displayed on the display section 54.

According to such a configuration, the color information of the target object W can be detected more accurately, and the detected color information can be displayed so it can be intuitively understood.

The spectroscopic measurement result display program according to the above embodiments is a program for causing a computer to perform a process of displaying the spectroscopic measurement result of the target object W on the display section 54. The spectroscopic measurement result display program causes a computer to perform a spectral image acquisition process, an Lab information generation process, and an Lab information display process. The spectral image acquisition process acquires a spectral image of the target object W. The Lab information generation process generates Lab visualization information (Lab-image 704 or Lab histogram 754) from the spectral image. In the Lab information display process, Lab visualization information is displayed on the display section 54.

According to such a configuration, it is possible to obtain a program capable of more accurately detecting color information of the target object W and displaying the detected color information so that the user can intuitively understand the detected color information.

The spectrometer, the spectroscopic measurement result display method, and the spectroscopic measurement result display program according to the present disclosure have been described based on the illustrated embodiments, but the present disclosure is not limited thereto.

For example, the spectrometer according to the present disclosure may be one in which any section of the above embodiments is replaced with an arbitrary component having the same function, or one in which an arbitrary component is added to the above embodiment. The spectroscopic measurement result display method according to the present disclosure may be obtained by adding an arbitrary target step to the above embodiments. Furthermore, the spectroscopic measurement result display program according to the present disclosure may be compressed or encrypted.

1. A spectrometer comprising:
a spectroscopic measurement section that performs spectroscopic measurement of a target object and acquires a spectral image;
a display section; and
a control section that generates Lab visualization information from the spectral image and displays the Lab visualization information on the display section.

2. The spectrometer according to claim 1, wherein
the Lab visualization information is an L-image obtained by converting an L-value into luminance for each pixel, an a-image obtained by converting an a-value into luminance for each pixel, or a b-image obtained by converting a b-value into luminance for each pixel.

3. The spectrometer according to claim 2, wherein
the control section sets a range of each luminance of the L-image, the a-image, or the b-image based on each range of the extracted L-values, a-values, or b-values.

4. The spectrometer according to claim 2, wherein
the control section includes an image processing section that performs a binarization process on the L-image, the a-image, or the b-image, and afterward performs a blob detection process on the L-image, the a-image, or the b-image that was subjected to the binarization process.

5. The spectrometer according to claim 1, wherein
the Lab visualization information is an L-histogram obtained by graphing the frequency of L-values for each bin, an a-histogram obtained by graphing the frequency of a-values for each bin, or a b-histogram obtained by graphing the frequency of b-values for each bin.

6. The spectrometer according to claim 5, wherein
the control section sets a range of each bin of the L-histogram, the a-histogram, or the b-histogram based on each range of the extracted L-values, a-values, or b-values.

7. The spectrometer according to claim 5, wherein
the frequency for each bin obtained from the spectral image is measurement data and the frequency of the reference set for each bin is reference data and
the control section has an accept or reject judgment section that calculates the ratio of the measurement data to the reference data for each bin and that makes an accept or reject judgement on the measurement data based on the correlation coefficient of the distribution of the obtained ratio.

8. The spectrometer according to claim 5, wherein
the frequency for each bin obtained from the spectral image is measurement data and the frequency of the reference set for each bin is reference data and
the control section has an accept or reject judgment section that calculates an error ratio between the reference data and the measurement data and that makes an accept or reject judgement on the measurement data based on the error ratio.

9. The spectrometer according to claim 5, wherein
the frequency for each bin obtained from the spectral image is measurement data, the frequency of acceptance set for each bin is acceptance data, and the frequency of rejection set for each bin is rejection data and
the control section has an accept or reject judgment section that makes an accept or reject judgement on the measurement data based on the Mahalanobis distance from the acceptance data to the measurement data and the Mahalanobis distance from the rejection data to the measurement data.

10. The spectrometer according to claim 3, further comprising:
an input section, wherein
the control section has a normalization process section for acquiring each range of the L-values, the a-values, or the b-values in a two dimensional region input via the input section as the range.

11. The spectrometer according to claim 3, further comprising:
an input section, wherein
the control section has a normalization process section for acquiring specified values input via the input section as respective ranges.

12. The spectrometer according to claim 11, wherein
the control section has a display control section for displaying, side by side on the display section, the Lab visualization information and an input reception screen, which is for receiving input of the specified values.

13. The spectrometer according to claim 1, wherein
the control section includes
an environment setting value reception section that receives an environment setting value including at least one of a color matching function and an illumination light source and
an Lab information calculation section that generates the Lab visualization information based on the spectral image and the environment setting value.

14. A method of displaying a spectroscopic measurement result of a target object on a display section, the spectroscopic measurement result display method comprising:
acquiring a spectral image of the target object;
generating Lab visualization information from the spectral image; and
displaying the Lab visualization information on the display section.

15. A non-transitory computer-readable storage medium storing a program, the program being
a spectroscopic measurement result display program for causing a computer to perform a process of displaying a spectroscopic measurement result of a target object on a display section,
the spectroscopic measurement result display program causing a computer to perform:
a spectral image acquisition process of acquiring a spectral image of the target object;
an Lab information generation process of generating Lab visualization information from the spectral image; and
an Lab information display process for displaying the Lab visualization information on the display section.
